(19) United States
(12) Patent Application Publication
(10) Pub. No.: US 2019/0019111 A1
(43) Pub. Date: Jan. 17, 2019

(54) BENCHMARK TEST METHOD AND DEVICE FOR SUPERVISED LEARNING ALGORITHM IN DISTRIBUTED ENVIRONMENT

(71) Applicant: ALIBABA GROUP HOLDING LIMITED, George Town (KY)

(72) Inventor: Zhongying SUN, Hangzhou (CN)

(73) Assignee: ALIBABA GROUP HOLDING LIMITED

(21) Appl. No.: 16/134,939

(22) Filed: Sep. 18, 2018

Related U.S. Application Data
(63) Continuation of application No. PCT/CN2017/075854, filed on Mar. 7, 2017.

(30) Foreign Application Priority Data
Mar. 18, 2016 (CN) 201610158881.9

(51) Int. Cl. G06N 99/00; G06F 11/36; G06F 11/34; G06F 11/30

(52) U.S. Cl. CPC G06N 99/005; G06F 11/3006; G06F 11/3428; G06F 11/3688

(57) ABSTRACT

There is provided a benchmark test method and device for a supervised learning algorithm in a distributed environment. The method includes: acquiring a first benchmark test result determined according to output data in a benchmark test; acquiring a distributed performance indicator in the benchmark test, and determining the distributed performance indicator as a second benchmark test result; and obtaining a combined benchmark test result by combining the first benchmark test result and the second benchmark test result.

### CROSS-REFERENCE TO RELATED APPLICATION

This application claims priority to International Application No. PCT/CN2017/075854, filed on Mar. 7, 2017, which claims priority to and the benefits of priority to Chinese Patent Application No. 201610158881.9 filed on Mar. 18, 2016, both of which are incorporated herein by reference in their entireties.

### TECHNICAL FIELD

The present disclosure relates to the field of machine learning technologies, and more particularly to a benchmark test method and device for a supervised learning algorithm in a distributed environment.

### BACKGROUND

Machine learning is an interdisciplinary domain emerging in the last two decades. It involves various subjects such as probability theory, statistics, approximation theory, convex analysis, and algorithm complexity theory. Machine learning can use algorithms, for example, for automatically analyzing data to find rules and applying the rules to predict unknown data.

Currently, machine learning has been widely applied. For example, machine learning has been applied to data mining, computer vision, natural language processing, biometric identification, search engine, medical diagnosis, credit card fraud detection, securities market analysis, DNA sequencing, speech and handwriting recognition, strategy games, and robot applications.

In the machine learning field, supervised learning, unsupervised learning and semi-supervised learning are three machine learning technologies that have been intensively studied and widely applied. The three learning technologies are described briefly as follows.

In supervised learning, a function is generated by using an existing correspondence between some input data and output data to map an input to a suitable output, for example, a classification. In unsupervised learning, an input data set is directly modeled, for example, clustered. In semi-supervised learning, labeled data and unlabeled data are comprehensively used to generate a suitable classification function.

Depending on different deployment structures, supervised learning is classified into supervised learning in a standalone environment and supervised learning in a distributed environment. Supervised learning in a distributed environment is a supervised learning solution that uses a plurality of devices that have the same or different physical structures and at different physical locations to execute a supervised learning algorithm.

Due to the complexity in device deployment, supervised learning in a distributed environment involves much resource coordination communication and many consumption factors. This makes it difficult to benchmark (or assess the performance of) a supervised learning algorithm in a distributed environment.

Currently, no complete, effective solution has been proposed for the benchmark test problem of a supervised learning algorithm in a distributed environment.

### SUMMARY

In view of the above problems, embodiments of the present disclosure provide a benchmark test method for a supervised learning algorithm in a distributed environment and a corresponding device for a supervised learning algorithm in a distributed environment to overcome the above problems or at least partly solve the above problems.

In accordance to some embodiments of the disclosure, there is provided a benchmark test method for a supervised learning algorithm in a distributed environment The method includes acquiring a first benchmark test result determined according to output data in a benchmark test. The method also includes acquiring a distributed performance indicator in the benchmark test, and determining the distributed performance indicator as a second benchmark test result The method further includes obtaining a combined benchmark test result by combining the first benchmark test result and the second benchmark test result.

According to some embodiments of the disclosure, there is also provided a benchmark test system for a supervised learning algorithm in a distributed environment. The system includes one or more memories configured to store executable program code and one or more processors configured to read the executable program code stored in the one or more memories to cause the benchmark test system to perform the following. A first benchmark test result determined according to output data in a benchmark test is acquired. A distributed performance indicator in the benchmark test is acquired. The distributed performance indicator is determined as a second benchmark test result. A combined benchmark test result is obtained by combining the first benchmark test result and the second benchmark test result.

According to some embodiments of the disclosure, there is further provided a non-transitory computer-readable storage medium storing a set of instructions that is executable by one or more processors of one or more electronic devices to cause the one or more electronic devices to perform a benchmark test method for a supervised learning algorithm in a distributed environment. The method includes acquiring a first benchmark test result determined according to output data in a benchmark test. The method also includes acquiring a distributed performance indicator in the benchmark test, and determining the distributed performance indicator as a second benchmark test result. The method further includes obtaining a combined benchmark test result by combining the first benchmark test result and the second benchmark test result.

The embodiments of the present disclosure may provide the following advantages. In some embodiments of the present disclosure, a first benchmark test result determined according to output data in a benchmark test is acquired, and a second benchmark test result is obtained by acquiring a distributed performance indicator in the benchmark test. Then, the first benchmark test result and the second benchmark test result are combined to obtain a combined benchmark test result that includes performance analysis indicators in different dimensions. Because the performance indicators in multiple dimensions can represent the operating performance of the algorithm to a great extent, those skilled in the art can perform a more comprehensive, accurate performance assessment on the supervised learning algorithm in the distributed environment by analyzing the benchmark test results in different dimensions. Assessment errors caused by undiversified performance indicators may also be avoided.

Further, because the second benchmark test result includes distributed performance indicators acquired from the distributed system and the distributed performance indicators can more accurately reflect current hardware consumption of the system when the distributed system runs the supervised learning algorithm, the current performance of the distributed system running the algorithm can be more accurately and quickly determined by comprehensively analyzing the distributed performance indicators and the first benchmark test result. Thus, the problem in the conventional art that a benchmark test may not be performed on a supervised learning algorithm in a distributed environment due to the lack of a more complete solution for performing a benchmark test on a supervised learning algorithm in a distributed environment may be overcome.

### BRIEF DESCRIPTION OF THE DRAWINGS

FIG. 1 is a flowchart of an exemplary benchmark test method for a supervised learning algorithm in a distributed environment according to some embodiments of the present disclosure;

FIG. 2 is a flowchart n exemplary benchmark test method for a supervised learning algorithm in a distributed environment according to some embodiments of the present disclosure;

FIG. 3 is a structural block diagram of an exemplary benchmark test device for a supervised learning algorithm in a distributed environment according to some embodiments of the present disclosure;

FIG. 4 is a structural block diagram of an exemplary benchmark test device for a supervised learning algorithm in a distributed environment according to some embodiments of the present disclosure;

FIG. 5 is a structural block diagram of an exemplary benchmark test device for a supervised learning algorithm in a distributed environment according to some embodiments of the present disclosure;

FIG. 6 is a schematic diagram of an exemplary logical sequence of data type classification in each round of benchmark test according to some embodiments of the present disclosure;

FIG. 7 is a structural diagram of an exemplary benchmark test system for a supervised learning algorithm in a distributed environment according to some embodiments of the present disclosure;

FIG. 8 is a service flowchart of an exemplary method for performing a Benchmark test by using a cross-validation model and a Label proportional distribution model according to some embodiments of the present disclosure; and

FIG. 9 is a flowchart of an exemplary method for processing of a supervised learning algorithm in a distributed environment according to some embodiments of the present disclosure.

### DETAILED DESCRIPTION

To make the above objectives, features and advantages of the present disclosure more comprehensible, the present disclosure is described in further detail below with reference to the accompanying drawings and specific implementations.

In terms of resource usage, supervised learning in a distributed environment and conventional supervised learning in a standalone environment are different from each other in that it is difficult to compute and collect statistics about resources for supervised learning in a distributed environment. Taking 128M training data as an example, CPU and memory usage during execution of a supervised learning algorithm can be easily computed in a standalone environment. However, when a supervised learning algorithm is executed in a distributed environment, all computing resources are formed by data results generated by several machines.

Taking a cluster of five two-core 4G-memory machines as an example, the total resource is 10 cores and 20G. Assuming that training data of a supervised learning algorithm is 128M and the 128M training data is to be expanded at the training stage, the data may be sliced in a distributed environment according to the data volume, and corresponding resources are applied for. For example, the training data is expanded to 1G and there is 256M data per instance, and then four instances may be needed to complete the task of the algorithm. Assuming that CPU and memory for each instance is dynamically applied for, and because there are four instances running at the same time and various resources are coordinated in the distributed environment, CPU and memory consumed by the task may need to be obtained by simultaneously calculating resource consumption of the four instances. However, it is difficult to collect statistics about resource consumption of each instance.

In view of the difficulty in collecting statistics about resource consumption in a distributed environment, one of core ideas of the embodiments of the present disclosure is as follows. A first benchmark test result determined according to output data in a benchmark test is acquired. A distributed performance indicator in the benchmark test is acquired, and the distributed performance indicator is determined as a second benchmark test result. A combined benchmark test result is obtained by combining the first benchmark test result and the second benchmark test result.

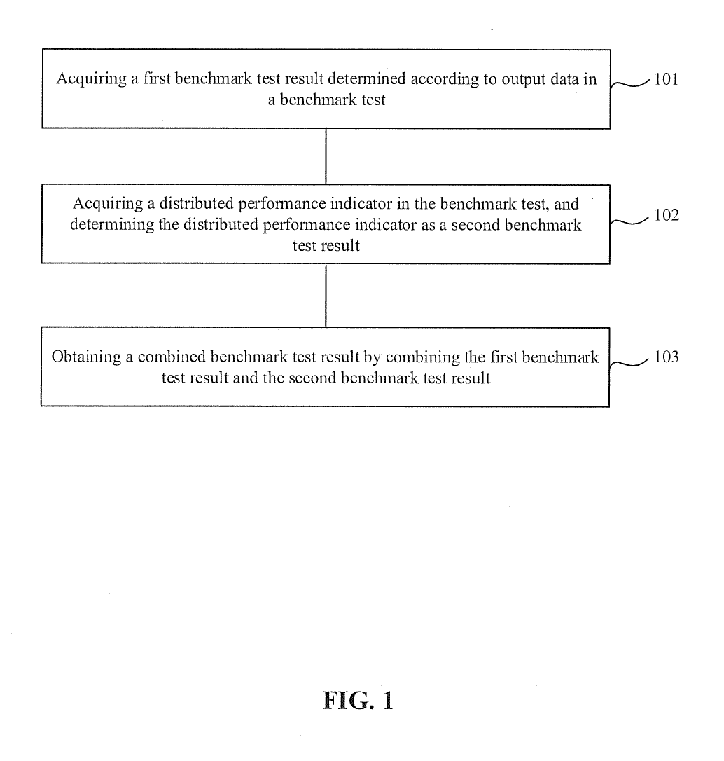

Referring to FIG. 1, a flowchart of an exemplary benchmark test method for a supervised learning algorithm in a distributed environment according to some embodiments of the present disclosure is shown. The method may include steps 101-103.

In step 101, a first benchmark test result determined according to output data in a benchmark test is acquired. A first benchmark test result may be determined based on output data obtained in a benchmark test process. The first benchmark test result is an analytical result obtained by analyzing the output data. In specific applications, the first benchmark test result may include at least one of the following performance indicators: true positive rate (True Positives, TP), true negative rate (True Negative, TN), false positive rate (False Positives, FP), false negative rate (False Negative, FN), precision (Precision), recall rate (Recall), or accuracy (Accuracy).

In step 102, a distributed performance indicator in the benchmark test is acquired, and the distributed performance indicator is determined as a second benchmark test result. Specifically, in the benchmark test process of the supervised learning algorithm in the distributed environment, the distributed performance indicator to be acquired is hardware consumption information generated in the benchmark test process of the supervised learning algorithm. For example, such information can include processor usage (CPU), memory usage (MEM), algorithm iteration count (Iterate), algorithm usage time (Duration), or the like.

It is noted that in specific applications, those skilled in the art may also determine, according to different assessment models that are actually selected, the performance indicators included in the first benchmark test result and the second benchmark test result. Contents of the performance indicators are not limited in the present disclosure.

In step 103, a combined benchmark test result is obtained by combining the first benchmark test result and the second benchmark test result. In specific applications, performance indicator data in the first benchmark test result and the second benchmark test result may be presented together in various forms such as a table, graph, or curve. For example, referring to Table 1, the combined benchmark test result obtained through combining is presented in the form of an assessment dimension table:

TABLE 1

| | | | | | | | |
|---|---|---|---|---|---|---|---|
| TP | FP | TN | FN | CPU | MEM | Iterate | Duration |

It is readily understood that regardless of the form in which the combined benchmark test result is presented, the combined benchmark test result can reflect the performance indicator information of an algorithm in a plurality of dimensions. Based on the information, technical staff with professional knowledge can analyze the information and assess the performance of the to-be-tested supervised learning algorithm. Namely, the method provided in these embodiments of the present disclosure can assist technical staff in performing a performance assessment on a supervised learning algorithm.

To sum up, in these embodiments of the present disclosure, a first benchmark test result determined according to output data in a benchmark test is acquired. A second benchmark test result is obtained by acquiring a distributed performance indicator in the benchmark test. Then, the first benchmark test result and the second benchmark test result are combined to obtain a combined benchmark test result, which includes performance analysis indicators in different dimensions. Because the performance indicators in multiple dimensions can represent the operating performance of the algorithm to a great extent, those skilled in the art can perform a more comprehensive, accurate performance assessment on the supervised learning algorithm in the distributed environment by analyzing benchmark test results in different dimensions. Assessment errors caused by undiversified performance indicators may also be avoided.

Further, because the second benchmark test result includes distributed performance indicators acquired from the distributed system and the distributed performance indicators can more accurately reflect current hardware consumption of the system when the distributed system runs the supervised learning algorithm, the current performance of the distributed system running the algorithm can be more accurately and quickly determined by comprehensively analyzing the distributed performance indicators and the first benchmark test result. Thus, the problem in the conventional art that a benchmark test may not be performed on a supervised learning algorithm in a distributed environment due to the lack of a more complete solution for performing a benchmark test on a supervised learning algorithm in a distributed environment may be overcome.

In addition, a benchmark test platform can be built based on the benchmark test method provided in these embodiments of the present disclosure. The benchmark test method or platform can make an analysis based on output data and distributed performance indicators acquired during the execution of a supervised learning algorithm in a distributed environment, and thus perform a comprehensive, accurate performance assessment on the supervised learning algorithm in the distributed environment.

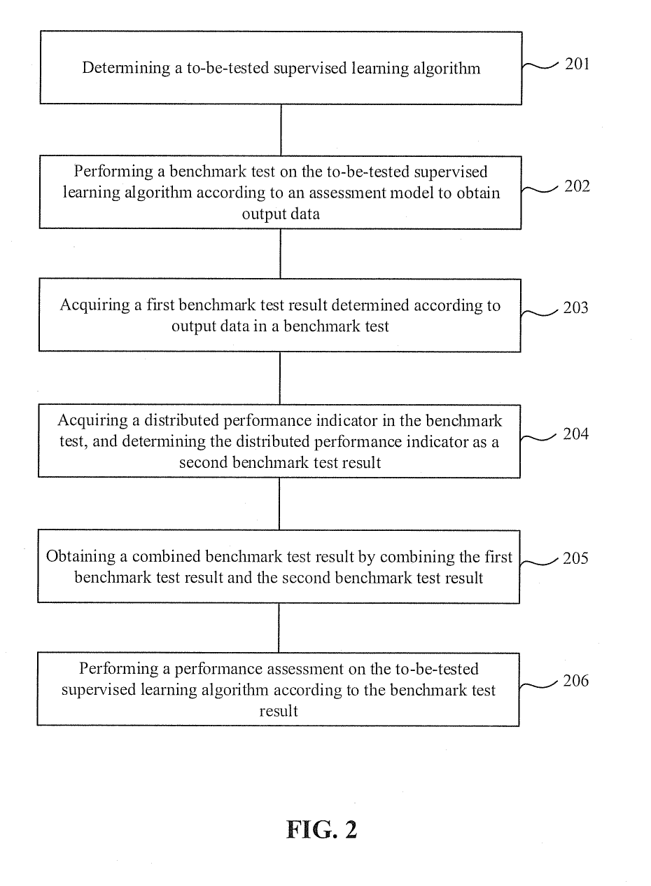

Referring to FIG. 2, a flowchart of an exemplary benchmark test method for a supervised learning algorithm in a distributed environment according to some embodiments of the present disclosure is shown. The method may include steps 201-206.

In step 201, a to-be-tested supervised learning algorithm is determined. Specifically, in this step, a to-be-tested supervised learning algorithm is to be determined. Then, a benchmark test is performed on the to-be-tested supervised learning algorithm to assess the performance of the to-be-tested supervised learning algorithm.

With the wide application of machine learning technologies, various learning algorithms are developed for different application scenarios in different fields. Accordingly, assessing the performance of different learning algorithms becomes an important topic.

The method provided in these embodiments of the present disclosure mainly performs a benchmark test on a supervised learning algorithm in a distributed environment.

This step allows selection by a user. During actual implementation, the user may directly submit a supervised learning algorithm to a benchmark test system. The benchmark test system determines the received supervised learning algorithm as a to-be-tested supervised learning algorithm. Alternatively, the user selects, in a selection interface in the benchmark test system, a supervised learning algorithm to be tested, and the benchmark test system determines the supervised learning algorithm selected by the user as a to-be-tested supervised learning algorithm.

In step 202, a benchmark test is performed on the to-be-tested supervised learning algorithm according to an assessment model to obtain output data. Before this step, an assessment model is set in advance. The model has a function of performing a benchmark test on the to-be-tested supervised learning algorithm.

Specifically, in the algorithm assessment field, a cross-validation model and a Label proportional distribution model are two widely used models having high accuracy and algorithm stability. Therefore, in the embodiments of the present disclosure, the method provided by the present disclosure is described by using the two models as examples of the assessment model.

That is, in step 202, the assessment model includes: a cross-validation model or a Label proportional distribution model.

Therefore, the performing a benchmark test on the to-be-tested supervised learning algorithm according to an assessment model to obtain output data includes: performing a benchmark test on the to-be-tested supervised learning algorithm according to a cross-validation model to obtain output data; or, performing a benchmark test on the to-be-tested supervised learning algorithm according to a Label proportional distribution model to obtain output data; or, performing a benchmark test on the to-be-tested supervised learning algorithm respectively according to the cross-validation model and the Label proportional distribution model.

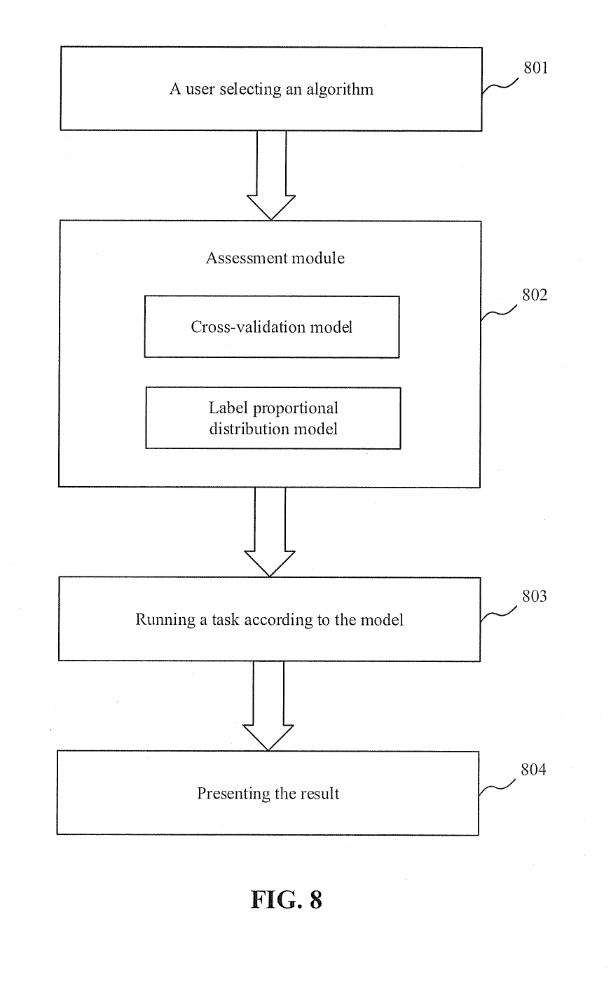

Referring to FIG. 8, FIG. 8 is a service flowchart of an exemplary method for performing a benchmark test by using a cross-validation model and a Label proportional distribution model according to some embodiments of the present disclosure. In specific implementations, as shown in FIG. 8, the user may select (801) any of the above two models (802) as required to run the task (803) and obtain and present a result (804).

In some embodiments of the present disclosure, the performing of a benchmark test on the to-be-tested supervised learning algorithm according to a cross-validation model to obtain output data includes steps I to III.

In step I, a test data sample is obtained. Specifically, the test data sample is generally a measured data sample. The data sample includes a plurality of pieces of data. Each piece of data includes input data and output data. Values of an input and an output of each piece of data generally are all measured values and may also be referred to as standard input data and standard output data respectively. For example, in a data sample for predicting a price of a housing, an input of each piece of data is the size of the housing, and a corresponding output is an average price, with specific values all being true values acquired.

In step II, data in the test data sample is equally divided into N portions.

In step III, M rounds of benchmark tests are executed on the N portions of data. Each round of benchmark test includes the following steps. In the N portions of data, N−1 portions are determined as training data and the remaining one portion is determined as prediction data. In the M rounds of benchmark tests, each portion of data has only one chance to be determined as prediction data, and M and N are positive integers. The determined N−1 portions of training data are provided to the to-be-tested supervised learning algorithm for learning to obtain a function. Input data in the determined one portion of prediction data is provided to the function to obtain output data.

The method for performing a benchmark test on the to-be-tested supervised learning algorithm according to a cross-validation model to obtain output data is described in detail below with reference to a specific application example.

It is assumed that a test data sample 1 including 1000 pieces of data is obtained, and according to a preset rule, N=5. Therefore, the benchmark test system first equally divides data in the test data sample 1 into five portions: data 1, data 2, data 3, data 4, and data 5, with each portion including 200 pieces of data. The value of M is also 5, i.e., the benchmark test system performs five rounds of benchmark tests on the five portions of data.

In each round of benchmark test, the type of the data is classified. Specifically, N−1=4, and therefore, four portions are selected as training data and one portion is selected as prediction data.

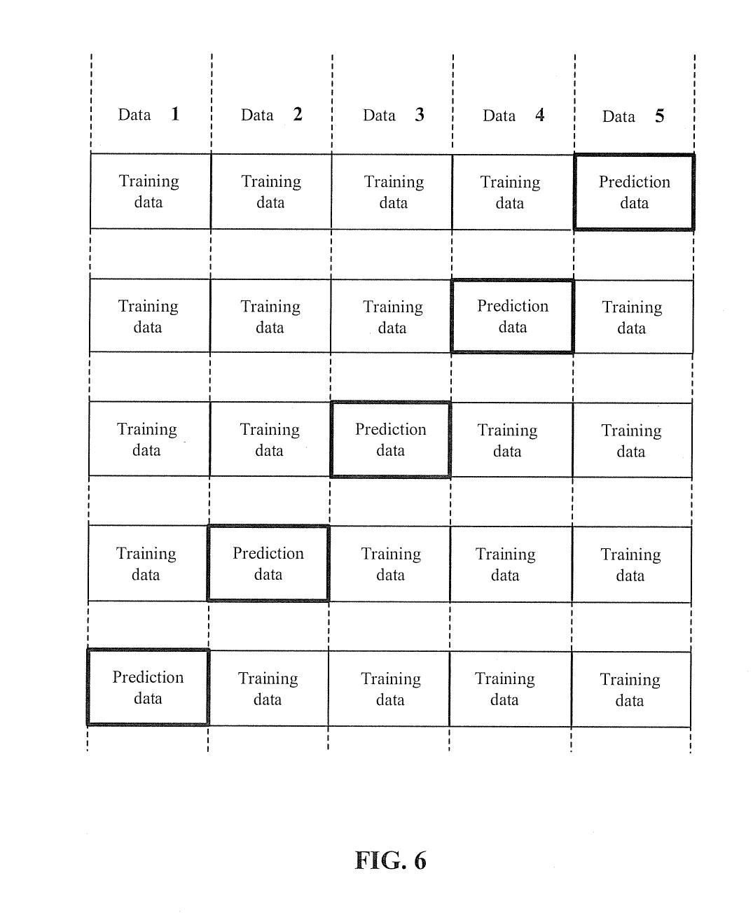

FIG. 6 is a schematic diagram of an exemplary data type classification method according to some embodiments of the present disclosure. As shown in FIG. 6, each row shows a data classification manner of five portions of data in one round of benchmark test. In each row, classification of data 1 to data 5 is shown in sequence from left to right. In the first row, data 1 to data 4 are classified as training data, and data 5 is classified as prediction data. In the second row, data 1 to data 3 and data 5 are classified as training data, and data 4 is classified as prediction data. In the third row, data 1, data 2, data 4, and data 5 are training data, and data 3 is prediction data. The rest can be deduced by analogy. In the fourth row, data 2 is prediction data, with the rest being training data. In the fifth row, data 1 is prediction data, with the rest being training data. After the data classification is completed, five rounds of benchmark tests are performed on the data. In each round of benchmark test, the determined four portions of training data are provided to the to-be-tested supervised learning algorithm for learning to obtain a function (or referred to as a model), and then, input data in the remaining one portion, i.e., in the prediction data, is provided to the function, thus obtaining output data. The output data is a predicted value obtained from the input data through prediction using the function. As such, after five rounds of benchmark tests are completed, five groups of output data can be obtained.

It is noted that in the five rounds of benchmark tests, the type of data in each round of benchmark test process may be classified according to a logical sequence in the manner shown in FIG. 6. Alternatively, the type of data in the benchmark test process may be classified according to other logical sequences. For example, the order of rows in the vertical direction in FIG. 6 may be changed, as long as each portion of data has only one chance to be determined as prediction data in the M rounds of benchmark tests.

In some embodiments of the present disclosure, the performing of a benchmark test on the to-be-tested supervised learning algorithm according to a Label proportional distribution model to obtain output data includes steps. I to III

In step I, a test data sample is obtained, wherein the test data sample includes data having a first label and data having a second label. It is noted that in this solution, the test data sample includes and only includes data having a first label and data having a second label. The first label and the second label are labels for classifying data based on particular requirements. Therefore, this solution is applied to a two-category scenario including two types of data.

In step II, the data having the first label and the data having the second label in the test data sample are equally divided into N portions respectively.

In step III, M rounds of benchmark tests is executed on the N portions of data. Each round of benchmark test includes the following steps. In the N portions of data having the first label, one portion is determined as training data and remaining one or more portions are determined as prediction data. In the N portions of data having the second label, one portion is determined as training data and remaining one or more portions are determined as prediction data. M and N are positive integers. The determined training data having the first label and the second label are provided to the to-be-tested supervised learning algorithm for learning to obtain a function. Input data in the determined prediction data having the first label and the second label are provided to the function to obtain output data.

Specifically, the first label and the second label are merely used for distinguishing different labels, and are not intended to be limiting. In actual applications, the first label and the second label may use different marking symbols. For example, the first label is 1 and the second label is 0; or the first label is Y and the second label is N; and so on.

A method for performing a benchmark test on the to-be-tested supervised learning algorithm according to a Label proportional distribution model is described in detail below with reference to an application example.

The Label proportional distribution model is to perform classification according to label values, equally divide data of each type, and then perform training by using combinations of different proportions.

It is assumed that a test data sample 2 includes 1000 pieces of data, where label values of 600 pieces of data are 1, and label values of 400 pieces of data are 0. According to the Label proportional distribution model, 600 pieces of data having a label value of 1 may be divided into 10 portions each including 60 pieces of data, and 400 pieces of data having a label value of 0 are also divided into 10 portions each including 40 pieces of data. A method for dividing the test data sample 2 is as shown in Table 2, where each row represents one portion of data. Data 1 to data 10 represent 10 portions of data having a Label value of 1, and data 11 to data 20 represent 10 portions of data having a Label value of 0.

TABLE 2

| Test data Sample 2 | Label |
|---|---|
| Data 1 | 1 |
| Data 2 | 1 |
| Data 3 | 1 |
| Data 4 | 1 |
| Data 5 | 1 |
| Data 6 | 1 |
| Data 7 | 1 |
| Data 8 | 1 |
| Data 9 | 1 |
| Data 10 | 1 |
| Data 11 | 0 |
| Data 12 | 0 |
| Data 13 | 0 |
| Data 14 | 0 |
| Data 15 | 0 |
| Data 16 | 0 |
| Data 17 | 0 |
| Data 18 | 0 |
| Data 19 | 0 |
| Data 20 | 0 |

When performing a benchmark test, the benchmark test system may determine one portion of data having a label value of 1 and one portion of data having a label value of 0 as training data, and determine another portion of data having a label value of 1 and another portion of data having a label value of 0 as prediction data, or determine one or more portions of data having a label value of 1 and one or more portions of data having a label value of 0 as prediction data.

After the data classification is completed, a benchmark test can be performed on the data. Assuming that M=4, four rounds of benchmark tests are performed. In each round of benchmark test, the determined training data is provided to the to-be-tested supervised learning algorithm for learning to obtain a function (or referred to as a model), and then input data in the prediction data is provided to the function, thus obtaining output data. The output data is a predicted value obtained from the input data through prediction using the function. As such, after four rounds of benchmark tests are completed, four groups of output data can be obtained.

Correspondingly, the performing of a benchmark test on the to-be-tested supervised learning algorithm respectively according to the cross-validation model and the Label proportional distribution model is performing a benchmark test on the test data sample respectively according to the cross-validation model and the Label proportional distribution model to obtain one group of output data for each of the different assessment models, and determining the two groups of output data as output data of the entire benchmark test process.

In step 203, a first benchmark test result determined according to output data in a benchmark test is acquired. Specifically, after the output data is obtained through the benchmark test, a plurality of parameter indicators may be determined according to a deviation between the output data and the standard output data, i.e., output data in the test data sample corresponding to the input data. In specific applications, the first benchmark test result may include at least one of the following performance indicators: TP, TN, FP, FN, Precision, Recall, and Accuracy.

In step 204, a distributed performance indicator in the benchmark test is acquired, and the distributed performance indicator is determined as a second benchmark test result. Specifically, a system performance detection module in the benchmark test system can obtain various distributed performance indicators in the benchmark test process. The distributed performance indicators are the second benchmark test result. Specifically, the distributed performance indicators include at least one of the following indicators: processor usage (CPU) of the to-be-tested supervised learning algorithm, memory usage (MEM) of the to-be-tested supervised learning algorithm, an iteration count (Iterate) of the to-be-tested supervised learning algorithm, and usage time (Duration) of the to-be-tested supervised learning algorithm.

In step 205, a combined benchmark test result is obtained by combining the first benchmark test result and the second benchmark test result. When the benchmark test (that is, performance assessment) is performed on the to-be-tested supervised learning algorithm, a comprehensive analysis is made with reference to the first benchmark test result and the second benchmark test result.

Therefore, after the first benchmark test result and the second benchmark test result are obtained, the two benchmark test results are combined to generate a list corresponding to the results, and the list is displayed to the user through a display. When the user is able to assess and analyze the algorithm, the user may directly make a comprehensive analysis according to the data presented in the list, so as to assess the performance of the to-be-tested supervised learning algorithm.

An exemplary list of the combined benchmark test result is as shown in Table 3 below.

TABLE 3

| | | | | | | | | | | |
|---|---|---|---|---|---|---|---|---|---|---|
| TP | FP | TN | FN | Precision | Recall | Accuracy | CPU | MEM | Iterate | Duration |

The list may include one or more rows of output results. Each row of output result corresponds to a first benchmark test result and a second benchmark test result that are determined in one round of benchmark test. Alternatively, each row of output result corresponds to a first benchmark test result and a second benchmark test result that are determined through a comprehensive analysis of multiple rounds of benchmark tests. Table 3 is an exemplary list of the combined benchmark test result.

In step 206, a performance assessment is performed on the to-be-tested supervised learning algorithm according to the benchmark test result. Specifically, the performing of a performance assessment on the to-be-tested supervised learning algorithm includes the following. an F1 score is determined according to the first benchmark test result. A performance assessment is performed on the to-be-tested supervised learning algorithm in the following manner. When F1 scores are identical or close to each other, the smaller the Iterate value of a to-be-tested supervised learning algorithm becomes, the better the performance of the to-be-tested supervised learning algorithm is. According to this manner, the performance of the to-be-tested supervised learning algorithm can be directly assessed. That is, when F1 scores are identical or close to each other, an iteration count of the to-be-tested supervised learning algorithm is determined, and it is determined that a to-be-tested supervised learning algorithm having a smaller iteration count has better performance.

The F1 score may be considered as a weighted average of the accuracy and the recall rate of an algorithm, and is an important indicator for assessing the quality of the to-be-tested supervised learning algorithm, with its calculation formula being as follows:

$$F 1 = 2 \times \frac{Precision \times Recall}{Precision + Recall}$$

wherein both Precision and Recall are indicators in the first benchmark test result, and specifically Precision represents the precision and Recall represents the recall rate.

Therefore, in this performance assessment manner, the performance of the to-be-tested supervised learning algorithm can be assessed as long as values of precision, recall and the iteration count of the to-be-tested supervised learning algorithm are determined.

In addition, a performance assessment may also be performed on the to-be-tested supervised learning algorithm in the following manner. When F1 indicators are identical, it is determined that a to-be-tested supervised learning algorithm having a smaller CPU, MEM, Iterate, or Duration value has better performance.

In the above solution, both the benchmark test result and the F1 score may be output in the form of a list, making it convenient for technical staff to view and analyze. An exemplary list is as shown in Table 4 below. Table 4 is a schematic table showing that both the benchmark test result and the F1 score are output according to another example of the present disclosure.

TABLE 4

| | | | | | | | | | | | |
|---|---|---|---|---|---|---|---|---|---|---|---|
| F1 | TP | FP | TN | FN | Precision | Recall | Accuracy | CPU | MEM | Iterate | Duration |

In some embodiments of the present disclosure, after the performance assessment is performed on the to-be-tested supervised learning algorithm, the performance assessment result may be sent to the user. Specifically, the performance assessment result may be displayed on a display interface for viewing by the user, thus assisting the user in performing a performance assessment on the algorithm.

In some embodiments of the present disclosure, the method further includes the following. Whether a deviation of the F1 score is proper is determined. If it is determined that the deviation of the F1 score is proper, it is determined that the benchmark test is successful. If it is determined that the deviation of the F1 score is not proper, it is determined that the benchmark test is not successful, and alarm indication information is sent to the user. Because the F1 score is an important indicator for determining the performance of the to-be-tested supervised learning algorithm, in actual applications, the user may set in advance a standard value of the F1 score for different to-be-tested supervised learning algorithms and a deviation range. If the deviation of the F1 score falls within the range set by the user, it is determined that the benchmark test is successful. If the deviation of the F1 score falls out of the range set by the user, it is determined that the benchmark test is not successful, and the user may perform the test again.

To sum up, in the method provided in these embodiments of the present disclosure, an F1 value is determined by further analyzing the performance of the combined benchmark test result. Based on the F1 value, the operating performance of the supervised algorithm in the distributed environment can be directly determined and provided to the user, so that those skilled in the art can intuitively learn the operating performance of the supervised learning algorithm in the distributed environment from the output result. Compared with the above embodiments, the time required for analysis and determining can be reduced for the user because the user does not need to re-calculate the analysis indicators, thus further improving the analysis efficiency.

It is noted that for simplicity, the method embodiments are described as a series of action combinations, but it is understood that the embodiments of the present disclosure are not limited to the described order of actions, because some steps may be performed in a different order or simultaneously according to the embodiments of the present disclosure. It is also understood that the embodiments described herein are all preferred embodiments, and the actions involved in these embodiments may not be necessary for the embodiments of the present disclosure.

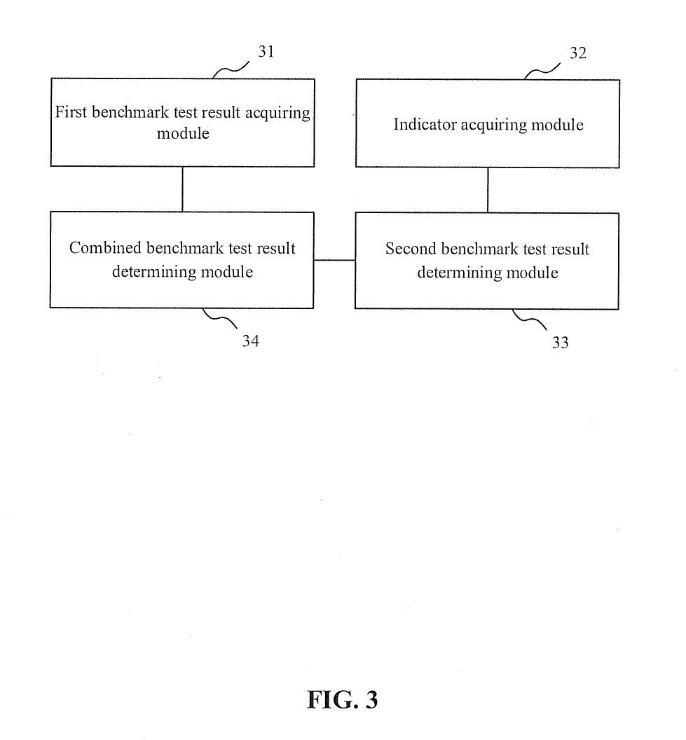

Referring to FIG. 3, a structural block diagram of an exemplary benchmark test device for a supervised learning algorithm in a distributed environment according to some embodiments of the present disclosure is shown. The device may include a first benchmark test result acquiring module 31, an indicator acquiring module 32, a second benchmark test result determining module 33, and a combined benchmark test result determining module 34.

First benchmark test result determining module 31 is configured to determine the first benchmark test result according to the output data in the benchmark test.

Indicator acquiring module 32 is configured to acquire a distributed performance indicator in the benchmark test.

Second benchmark test result determining module 33 is configured to determine the distributed performance indicator as a second benchmark test result.

Combined benchmark test result determining module 34 is configured to obtain a combined benchmark test result by combining the first benchmark test result and the second benchmark test result.

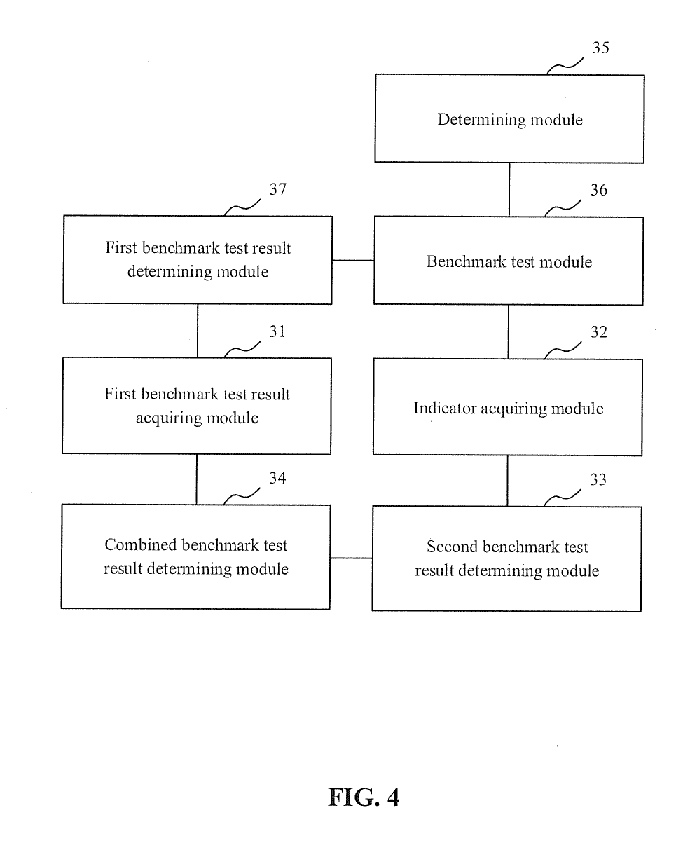

In some embodiments of the present disclosure, as shown in FIG. 4, the device further includes: a determining module 35 configured to determine a to-be-tested supervised learning algorithm before the first benchmark test result acquiring module acquires the first benchmark test result determined according to the output data in the benchmark test; a benchmark test module 36 configured to perform a benchmark test on the to-be-tested supervised learning algorithm according to an assessment model to obtain output data; and a first benchmark test result determining module 37 configured to determine the first benchmark test result according to the output data in the benchmark test.

Specifically, benchmark test module 36 is configured to perform a benchmark test on the to-be-tested supervised learning algorithm according to a cross-validation model to obtain output data; or, perform a benchmark test on the to-be-tested supervised learning algorithm according to a Label proportional distribution model to obtain output data; or, perform a benchmark test on the to-be-tested supervised learning algorithm respectively according to a cross-validation model and a Label proportional distribution model to obtain output data. Benchmark test module 36 includes a first benchmark test submodule and a second benchmark test submodule. The first benchmark test submodule is configured to perform a benchmark test on the to-be-tested supervised learning algorithm according to a cross-validation model or a Label proportional distribution model. The second benchmark test submodule is configured to perform a benchmark test on the to-be-tested supervised learning algorithm according to a cross-validation model or a Label proportional distribution model.

Specifically, the first benchmark test submodule includes: a first data obtaining unit configured to obtain a test data sample; a first equal division unit configured to equally dividing data in the test data sample into N portions; and a first determining unit configured to, in each round of benchmark test, determine, in the N portions of data, N−1 portions as training data and the remaining one portion as prediction data, wherein in the M rounds of benchmark tests, each portion of data has only one chance to be determined as prediction data, and M and N are positive integers; a first providing unit configured to, in each round of benchmark test, provide the determined N−1 portions of training data to the to-be-tested supervised learning algorithm for learning to obtain a function; and a second providing unit configured to, in each round of benchmark test, provide input data in the determined one portion of prediction data to the function to obtain output data.

Specifically, the second benchmark test submodule includes: a second data obtaining unit configured to obtain a test data sample, the test data sample including data having a first label and data having a second label; a second equal division unit configured to equally divide the data having the first label and the data having the second label in the test data sample into N portions respectively; and a second determining unit configured to, in each round of benchmark test, determine, in the N portions of data having the first label, one portion as training data and remaining one or more portions as prediction data, and determine, in the N portions of data having the second label, one portion as training data and remaining one or more portions as prediction data, wherein M and N are positive integers; a third providing unit configured to, in each round of benchmark test, provide the determined training data having the first label and the second label to the to-be-tested supervised learning algorithm for learning to obtain a function; and a fourth providing unit configured to, in each round of benchmark test, provide input data in the determined prediction data having the first label and the second label to the function to obtain output data.

Specifically, the first benchmark test result includes at least one of the following indicators: true positive rate (TP), true negative rate (TN), false positive rate (FP), false negative rate (FN), precision (Precision), recall rate (Recall), or accuracy (Accuracy). The second benchmark test result includes at least one of the following indicators: processor usage (CPU) of the to-be-tested supervised learning algorithm, memory usage (MEM) of the to-be-tested supervised learning algorithm, an iteration count (Iterate) of the to-be-tested supervised learning algorithm, or usage time (Duration) of the to-be-tested supervised learning algorithm.

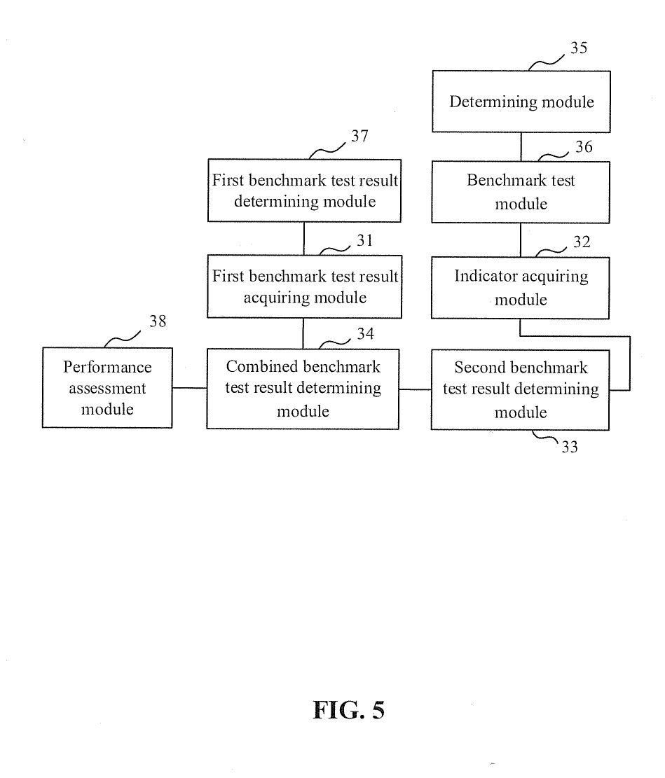

In some embodiments of the present disclosure, as shown in FIG. 5, the device further includes a performance assessment module 38 configured to determine an F1 score according to the first benchmark test result and perform a performance assessment on the to-be-tested supervised learning algorithm in the following manner. When F1 scores are identical or close to each other, it is determined that a to-be-tested supervised learning algorithm having a smaller Iterate value has better performance Alternatively, when F1 indicators are identical, it is determined that a to-be-tested supervised learning algorithm having a smaller CPU, MEM, Iterate, or Duration value has better performance.

The F1 score may be considered as a weighted average of the accuracy and the recall rate of an algorithm, and is an important indicator for assessing the quality of the to-be-tested supervised learning algorithm, with its calculation formula being as follows:

$$F 1 = 2 \times \frac{Precision \times Recall}{Precision + Recall}$$

wherein both Precision and Recall are indicators in the first benchmark test result, and specifically Precision represents the precision and Recall represents the recall rate.

During specific implementation, the first benchmark test result acquiring module 31, the indicator acquiring module 32, the second benchmark test result determining module 33, the combined benchmark test result determining module 34, the determining module 35, the benchmark test module 36, the first benchmark test result determining module 37, and the performance assessment module 38 may be implemented by a Central Processing Unit (CPU), a Micro Processing Unit (MPU), a Digital Signal Processor (DSP) or a Field-Programmable Gate Array (FPGA) in a benchmark test system.

Some portions of the device embodiments may be similar to the method embodiments and therefore are described briefly. For the relevant part, reference may be made to the part of the description of the method embodiments.

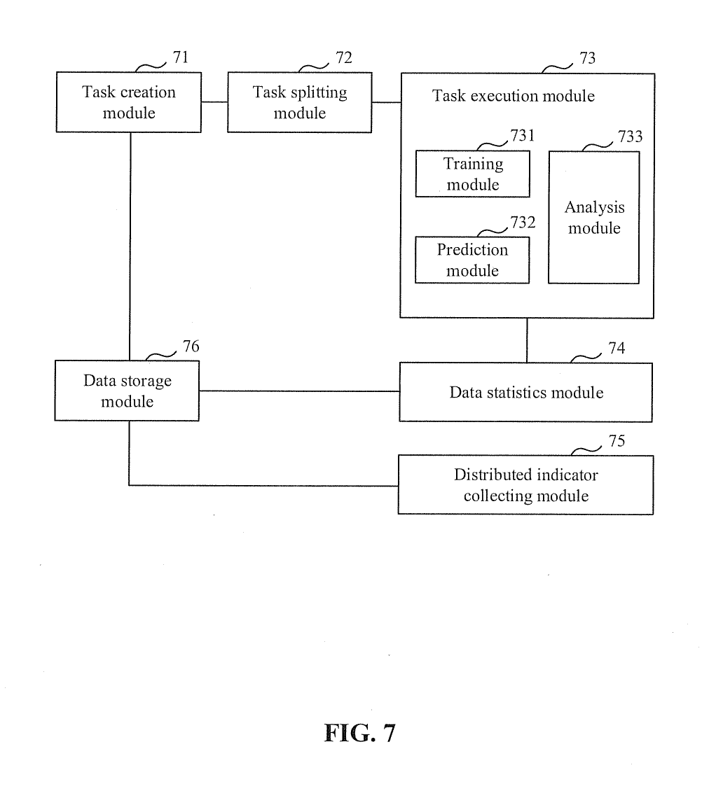

FIG. 7 is a structural diagram of an exemplary benchmark test system according to some embodiments of the present disclosure. The benchmark test system includes a task creation module 71, a task splitting module 72, a task execution module 73, a data statistics module 74, a distributed indicator collecting module 75, and a data storage module 76.

Task creation module 71 is configured to create a benchmark test task according to a user instruction. Specifically, the user determines a to-be-tested supervised learning algorithm, and creates a benchmark test task for the to-be-tested supervised learning algorithm.

Task splitting module 72 is configured to split the benchmark test task created according to the user instruction. When one or more to-be-tested supervised learning algorithms are set by the user, each to-be-tested supervised learning algorithm is split into one benchmark test task.

Task execution module 73 is configured to perform a benchmark test on the benchmark test task and generate test data.

Data statistics module 74 is configured to make statistics about benchmark test results generated. Specifically, the test data generated in the benchmark test process is combined to obtain a benchmark test result.

Distributed indicator collecting module 75 is configured to collect distributed indicators generated in the benchmark test process.

Data storage module 76 is configured to store the benchmark test result and the distributed indicators.

Task execution module 73 further includes a training module 731, a prediction module 732, and an analysis module 733. Training module 731 is configured to provide training data to the to-be-tested supervised learning algorithm for learning to obtain a function. Prediction module 732 is configured to provide prediction data to the function to obtain output data. Analysis module 733 is configured to generate test data according to the output data.

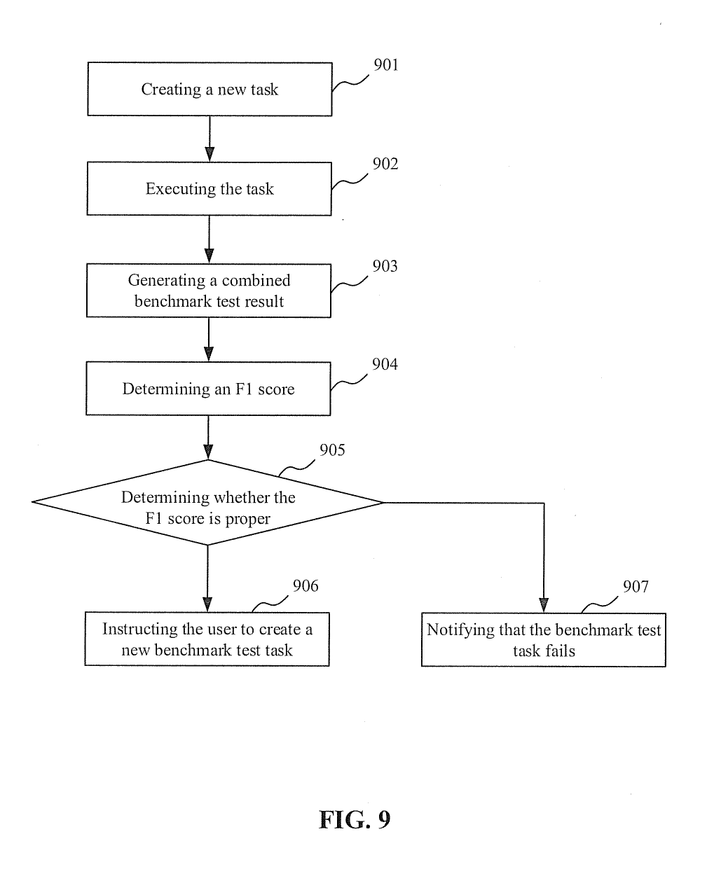

Based on the above benchmark test system, a flowchart an exemplary benchmark test method according to some embodiments of the present disclosure is as shown in FIG. 9. The method includes steps 901-907.

In step 901, a new task is created. Specifically, the user creates a new task as required. The task is for a particular supervised learning algorithm. Therefore, the user sets a to-be-tested supervised learning algorithm.

In step 902, the task is executed. Specifically, a benchmark test is performed on the supervised learning algorithm according to a cross-validation model or a proportional distribution model.

In step 903, a combined benchmark test result is generated. The combined benchmark test result includes: a benchmark test result that is determined according to test data when the benchmark test is performed on the supervised learning algorithm, and distributed indicators acquired during the execution of the benchmark test.

In step 904, an F1 score is determined. Specifically, the F1 score is determined according to the benchmark test result.

In step 905, whether the F1 score is proper is determined. When it is determined that the F1 score is proper, the process proceeds to step 906. When it is determined that the F1 score is not proper, the process proceeds to step 907.

In step 906, the user is instructed to create a new benchmark test task.

Meanwhile, the user is notified that the previous benchmark test task is successful.

In step 907, it is notified that the benchmark test task fails. Specifically, an indication message indicating that the benchmark test task fails is sent to the user.

The embodiments herein are described in a progressive manner. Each embodiment focuses on differences from other embodiments. For same or similar parts in the embodiments, reference may be made to each other.

As will be appreciated by those skilled in the art, the embodiments of the present disclosure may be embodied as a method, a system, or a computer program product. Accordingly, the present disclosure may use the form of an entirely hardware embodiment, an entirely software embodiment, or an embodiment combining software and hardware aspects. Furthermore, the embodiments of the present disclosure may use the form of a computer program product implemented on one or more computer-usable storage media (including but not limited to magnetic disk memories, CD-ROMs, optical memories, etc.) including computer-usable program code.

In a typical configuration, a computation device includes one or more central processing units (CPUs), data input/output interfaces, network interfaces, and memories. The memory may include the following forms of a computer readable medium: a volatile memory, a random access memory (RAM) or a non-volatile memory, for example, a read-only memory (ROM) or flash RAM. The memory is an example of the computer readable medium. The computer readable medium includes volatile and non-volatile, mobile and non-mobile media, and can use any method or technology to store information. The information may be a computer readable instruction, a data structure, a module of a program or other data. Examples of storage media of the computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be used for storing computer accessible information. According to the disclosure herein, the computer readable medium does not include transitory computer readable media (transitory media), for example, a modulated data signal and carrier. The computer readable medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

The embodiments of the present disclosure are described with reference to flowcharts or block diagrams of the method, terminal device (system) and computer program product in the embodiments of the present disclosure. It should be understood that computer program instructions can implement each process or block in the flowcharts or block diagrams and a combination of processes or blocks in the flowcharts or block diagrams. These computer program instructions may be provided to a computer, an embedded processor or a processor of another programmable data processing device to generate a machine, so that an apparatus configured to implement functions specified in one or more processes in the flowcharts or one or more blocks in the block diagrams is generated by using instructions executed by the general-purpose computer or the processor of another programmable data processing device.

These computer program instructions may also be stored in a computer readable memory that can guide a computer or another programmable data processing device to work in a specified manner, so that the instructions stored in the computer readable memory generate a product including an instruction apparatus, where the instruction apparatus implements functions specified in one or more processes in the flowcharts or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flowcharts or one or more blocks in the block diagrams.

Although preferred embodiments of the present disclosure have been described, those skilled in the art can make additional variations or modifications to the embodiments after learning the basic inventive concept. Therefore, the appended claims should be construed as including the preferred embodiments and all variations and modifications that fall within the scope of the embodiments of the present disclosure.

Finally, it should be further noted that as used herein, relational terms such as first and second are merely used for distinguishing one entity or operation from another entity or operation, and do not necessarily require or imply any actual relationship or sequence between entities or operations. In addition, the terms “include,” “comprise” or any other variation thereof are intended to cover a non-exclusive inclusion, such that a process, method, article, or device that includes a list of elements not only includes those elements but also may include other elements not expressly listed or elements inherent to such process, method, article, or device. An element modified by “comprising alan” or the like does not, without more constraints, preclude the existence of additional identical elements in the process, method, article, or device that includes the element.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The benchmark test method and device for a supervised learning algorithm in a distributed environment that are provided by the present disclosure are described in detail above. Specific examples are used in the specification to elaborate the principle and implementation of the present disclosure. However, the descriptions of the foregoing embodiments are merely used to facilitate the understanding of the method and core idea of the present disclosure. Those of ordinary skill in the art can make modifications to the specific implementation and the application scope according to the idea of the present disclosure. Therefore, the content of the specification should not be construed as limiting the present disclosure.

1. A benchmark test method for a supervised learning algorithm in a distributed environment, comprising:
acquiring a first benchmark test result determined according to output data in a benchmark test;
acquiring a distributed performance indicator in the benchmark test, and determining the distributed performance indicator as a second benchmark test result; and
obtaining a combined benchmark test result by combining the first benchmark test result and the second benchmark test result.

2. The method according to claim 1, wherein before the first benchmark test result is acquired, the method further comprises:
determining a to-be-tested supervised learning algorithm;
performing a benchmark test on the to-be-tested supervised learning algorithm according to an assessment model to obtain output data; and
determining the first benchmark test result according to the output data in the benchmark test.

3. The method according to claim 2, wherein performing the benchmark test on the to-be-tested supervised learning algorithm comprises one of the following:
performing the benchmark test on the to-be-tested supervised learning algorithm according to a cross-validation model to obtain output data;
performing the benchmark test on the to-be-tested supervised learning algorithm according to a Label proportional distribution model to obtain output data; or,
performing the benchmark test on the to-be-tested supervised learning algorithm according to a cross-validation model and a Label proportional distribution model to obtain output data respectively.

4. The method according to claim 3, wherein performing the benchmark test on the to-be-tested supervised learning algorithm according to the cross-validation model to obtain the output data comprises:
obtaining a test data sample;
equally dividing data in the test data sample into N portions; and
executing M rounds of benchmark tests on the N portions of data,
wherein each round of benchmark test comprises the following:
determining, in the N portions of data, N−1 portions as training data and the remaining one portion as prediction data, wherein in the M rounds of benchmark tests, each portion of data has one chance to be determined as prediction data, and M and N are positive integers;
providing the determined N−1 portions of training data to the to-be-tested supervised learning algorithm for learning to obtain a function; and
providing input data in the determined one portion of prediction data to the function to obtain the output data.

5. The method according to claim 3, wherein performing the benchmark test on the to-be-tested supervised learning algorithm according to the Label proportional distribution model to obtain the output data comprises:
obtaining a test data sample comprising data having a first label and data having a second label;
equally dividing the data having the first label and the data having the second label in the test data sample into N portions respectively; and
executing M rounds of benchmark tests on the 2N portions of data obtained through the equal division,
wherein each round of benchmark test comprises the following:
determining, in the N portions of data having the first label, one portion as training data and remaining one or more portions as prediction data, and determining, in the N portions of data having the second label, one portion as training data and remaining one or more portions as prediction data, wherein M and N are positive integers;
providing the determined training data having the first label and the second label to the to-be-tested supervised learning algorithm for learning to obtain a function; and
providing input data in the determined prediction data having the first label and the second label to the function to obtain the output data.

6. The method according to claim 2, wherein the first benchmark test result comprises at least one of the following indicators: true positive rate (TP), true negative rate (TN), false positive rate (FP), false negative rate (FN), precision (Precision), recall rate (Recall), or accuracy (Accuracy); and
the second benchmark test result comprises at least one of the following indicators: processor usage (CPU) of the to-be-tested supervised learning algorithm, memory usage (MEM) of the to-be-tested supervised learning algorithm, an iteration count (Iterate) of the to-be-tested supervised learning algorithm, or usage time (Duration) of the to-be-tested supervised learning algorithm.

7. The method according to claim 2, wherein after obtaining the combined benchmark test result, the method further comprises:
determining an F1 score according to the first benchmark test result; and
performing a performance assessment on the to-be-tested supervised learning algorithm by:
in response to F1 scores being identical or close to each other, determining that a to-be-tested supervised learning algorithm having a smaller Iterate value has better performance; and,
in response to F1 indicators being identical, determining that a to-be-tested supervised learning algorithm having a smaller CPU, MEM, Iterate, or Duration value has better performance.

8. A benchmark test system for a supervised learning algorithm in a distributed environment, comprising:
one or more memories configured to store executable program code; and
one or more processors configured to read the executable program code stored in the one or more memories to cause the benchmark test system to perform:
acquiring a first benchmark test result determined according to output data in a benchmark test;
acquiring a distributed performance indicator in the benchmark test;
determining the distributed performance indicator as a second benchmark test result; and
obtaining a combined benchmark test result by combining the first benchmark test result and the second benchmark test result.

9. The system according to claim 8, wherein the one or more processors are configured to read the executable program code to cause the benchmark test system to further perform:
determining a to-be-tested supervised learning algorithm before the first benchmark test result determined according to the output data in the benchmark test is acquired; and
performing a benchmark test on the to-be-tested supervised learning algorithm according to an assessment model to obtain the output data.

10. The system according to claim 9, wherein the one or more processors are configured to read the executable program code to cause the benchmark test system to further perform one of the following:
performing a benchmark test on the to-be-tested supervised learning algorithm according to a cross-validation model to obtain the output data;
performing a benchmark test on the to-be-tested supervised learning algorithm according to a Label proportional distribution model to obtain the output data; or
performing a benchmark test on the to-be-tested supervised learning algorithm respectively according to a cross-validation model and a Label proportional distribution model to obtain the output data.

11. The system according to claim 10, wherein the one or more processors are configured to read the executable program code to cause the benchmark test system to further perform:
obtaining a test data sample;
equally dividing data in the test data sample into N portions;
in each round of benchmark test, determining, in the N portions of data, N−1 portions as training data and the remaining one portion as prediction data, wherein in the M rounds of benchmark tests, each portion of data has one chance to be determined as prediction data, and M and N are positive integers;
in each round of benchmark test, providing the determined N−1 portions of training data to the to-be-tested supervised learning algorithm for learning to obtain a function; and
in each round of benchmark test, providing input data in the determined one portion of prediction data to the function to obtain the output data.

12. The system according to claim 10, wherein the one or more processors are configured to read the executable program code to cause the benchmark test system to further perform:
obtaining a test data sample comprising data having a first label and data having a second label;
equally dividing the data having the first label and the data having the second label in the test data sample into N portions respectively; and
in each round of benchmark test, determining, in the N portions of data having the first label, one portion as training data and remaining one or more portions as prediction data, and determining, in the N portions of data having the second label, one portion as training data and remaining one or more portions as prediction data, wherein M and N are positive integers;
in each round of benchmark test, providing the determined training data having the first label and the second label to the to-be-tested supervised learning algorithm for learning to obtain a function; and
in each round of benchmark test, providing input data in the determined prediction data having the first label and the second label to the function to obtain the output data.

13. The system according to claim 9, wherein the first benchmark test result comprises at least one of the following indicators: true positive rate (TP), true negative rate (TN), false positive rate (FP), false negative rate (FN), precision (Precision), recall rate (Recall), or accuracy (Accuracy); and
the second benchmark test result comprises at least one of the following indicators: processor usage (CPU) of the to-be-tested supervised learning algorithm, memory usage (MEM) of the to-be-tested supervised learning algorithm, an iteration count (Iterate) of the to-be-tested supervised learning algorithm, or usage time (Duration) of the to-be-tested supervised learning algorithm.

14. The system according to claim 9, wherein the one or more processors are configured to read the executable program code to cause the benchmark test system to further perform:
determining an F1 score according to the first benchmark test result and performing a performance assessment on the to-be-tested supervised learning algorithm by:
in response to F1 scores being identical or close to each other, determining that a to-be-tested supervised learning algorithm having a smaller Iteration count has better performance; and,
in response to F1 indicators being identical, determining that a to-be-tested supervised learning algorithm having a smaller CPU, MEM, Iterate, or Duration value has better performance.

15. A non-transitory computer-readable storage medium storing a set of instructions that is executable by one or more processors of one or more electronic devices to cause the one or more electronic devices to perform a benchmark test method for a supervised learning algorithm in a distributed environment, the method comprising:
acquiring a first benchmark test result determined according to output data in a benchmark test;
acquiring a distributed performance indicator in the benchmark test, and determining the distributed performance indicator as a second benchmark test result; and
obtaining a combined benchmark test result by combining the first benchmark test result and the second benchmark test result.

16. The non-transitory computer-readable storage medium of claim 15, wherein before the first benchmark test result is acquired, the set of instructions that is executable by the one or more processors of the one or more electronic devices causes the one or more electronic devices to further perform:
determining a to-be-tested supervised learning algorithm;
performing a benchmark test on the to-be-tested supervised learning algorithm according to an assessment model to obtain output data; and
determining the first benchmark test result according to the output data in the benchmark test.

17. The non-transitory computer-readable storage medium of claim 16, wherein the set of instructions that is executable by the one or more processors of the one or more electronic devices causes the one or more electronic devices to perform one of the following to perform the benchmark test on the to-be-tested supervised learning algorithm:
performing the benchmark test on the to-be-tested supervised learning algorithm according to a cross-validation model to obtain output data;
performing the benchmark test on the to-be-tested supervised learning algorithm according to a Label proportional distribution model to obtain output data; or,
performing the benchmark test on the to-be-tested supervised learning algorithm according to a cross-validation model and a Label proportional distribution model to obtain output data respectively.

18. The non-transitory computer-readable storage medium of claim 17, wherein the set of instructions that is executable by the one or more processors of the one or more electronic devices causes the one or more electronic devices to perform the following to perform the benchmark test on the to-be-tested supervised learning algorithm according to the cross-validation model to obtain the output data:
obtaining a test data sample;
equally dividing data in the test data sample into N portions; and
executing M rounds of benchmark tests on the N portions of data,
wherein each round of benchmark test comprises the following:
determining, in the N portions of data, N−1 portions as training data and the remaining one portion as prediction data, wherein in the M rounds of benchmark tests, each portion of data has one chance to be determined as prediction data, and M and N are positive integers;
providing the determined N−1 portions of training data to the to-be-tested supervised learning algorithm for learning to obtain a function; and
providing input data in the determined one portion of prediction data to the function to obtain the output data.

19. The non-transitory computer-readable storage medium of claim 17, wherein the set of instructions that is executable by the one or more processors of the one or more electronic devices causes the one or more electronic devices to perform the following to perform the benchmark test on the to-be-tested supervised learning algorithm according to the Label proportional distribution model to obtain the output data comprises:
obtaining a test data sample comprising data having a first label and data having a second label;
equally dividing the data having the first label and the data having the second label in the test data sample into N portions respectively; and
executing M rounds of benchmark tests on the 2N portions of data obtained through the equal division,
wherein each round of benchmark test comprises the following:
determining, in the N portions of data having the first label, one portion as training data and remaining one or more portions as prediction data, and determining, in the N portions of data having the second label, one portion as training data and remaining one or more portions as prediction data, wherein M and N are positive integers;
providing the determined training data having the first label and the second label to the to-be-tested supervised learning algorithm for learning to obtain a function; and
providing input data in the determined prediction data having the first label and the second label to the function to obtain the output data.

20. The non-transitory computer-readable storage medium of claim 16, wherein the first benchmark test result comprises at least one of the following indicators: true positive rate (TP), true negative rate (TN), false positive rate (FP), false negative rate (FN), precision (Precision), recall rate (Recall), or accuracy (Accuracy); and
the second benchmark test result comprises at least one of the following indicators: processor usage (CPU) of the to-be-tested supervised learning algorithm, memory usage (MEM) of the to-be-tested supervised learning algorithm, an iteration count (Iterate) of the to-be-tested supervised learning algorithm, or usage time (Duration) of the to-be-tested supervised learning algorithm.

21. The non-transitory computer-readable storage medium of claim 16, wherein after obtaining the combined benchmark test result, the set of instructions that is executable by the one or more processors of the one or more electronic devices causes the one or more electronic devices to further perform:
determining an F1 score according to the first benchmark test result; and
performing a performance assessment on the to-be-tested supervised learning algorithm by:
in response to F1 scores being identical or close to each other, determining that a to-be-tested supervised learning algorithm having a smaller Iterate value has better performance; and,
in response to F1 indicators being identical, determining that a to-be-tested supervised learning algorithm having a smaller CPU, MEM, Iterate, or Duration value has better performance.
